(19) United States
(12) Patent Application Publication
(10) Pub. No.: US 2006/0045948 A1
(43) Pub. Date: Mar. 2, 2006

(54) Chemical production of palatable carbonated ice

(76) Inventors: Lynndon Shilling, Altoona, IA (US); Laura Rusch-Salazar, Altoona, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/931,534

(22) Filed: Sep. 1, 2004

(51) Int. Cl. A23B 4/06

(52) U.S. Cl. 426/393

(57) ABSTRACT

A container and method for forming a palatable carbonated ice under pressure, includes a container having an outer wall with a lower end enclosed by a bottom wall and an upper end enclosed by a top wall to form an internal chamber. A water based fluid having sugar, such as a diet sweetener, and CO2 is located within the internal chamber. A portion of headspace between the water based fluid and the top wall sized to permit expansion of the water based fluid during freezing without rupturing the container. The container having a rupture strength greater than a conventional pop can of about 105 pounds per square inch. The top wall includes a removable portion that provides an opening to the internal chamber to facilitate the removal of palatable ice from the internal chamber, where the removable portion covers at least a majority of the surface of the top wall.

### BACKGROUND OF THE INVENTION

This invention is directed toward a method and means of chemically producing palatable carbonated ice.

Known in the ice confection art is to produce carbonated ice utilizing a CO₂-water liquid. The resultant carbonated ice is relatively hard and must be mechanically shaved or ground to produce palatable particles to be mixed with a flavored additive to finish the confection. Also known is that the addition of sugar containing syrups to the CO₂-water liquid, prior to completion of the freezing process, is disfavored as the presence of sugar in the CO₂-water liquid is known to produce undesirable foam, popping explosions and make the reaction less stable.

Thus, the known methods and means for forming confections with carbonated ice require complex machinery, and an extensive number of steps to result in a final confection. Accordingly, there is a need for a simplified method and means for forming palatable snow-like confections with carbonated ice.

Additionally, carbonated soft drink products are typically supplied in consumer friendly packaging such as bottles or cans. These conventional packaged soft drinks are unsuitable for freezing the contents into an ice confection, as the containers will significantly deform or explode, and removal of the contents is difficult at best.

Specifically, the total volume in a pop can is 12.95+/−0.06 fl. oz. When a pop can is filled in production there is a little more than 12 fl. oz. of carbonate beverage added to the can. This produces a headspace of a little less than ¼ inch in the can. This amount of headspace in a conventional can does not allow for formation of an ice confection as the ice breaks the seal at an excess of 105 pounds per square inch. Accordingly, there is a need for a simplified method and means for forming palatable snow-like confections with carbonated ice in consumer friendly packaging.

Therefore, a principal object of this invention is to provide a simplified apparatus for forming carbonated ice under pressure.

Another object of the invention is to provide a method of producing carbonated ice from a carbonated water based fluid including a sugar component.

These and other objects will be apparent to those skilled in the art.

### SUMMARY OF THE INVENTION

A container and method for forming a palatable carbonated ice under pressure, includes a container having an outer wall with a lower end enclosed by a bottom wall and an upper end enclosed by a top wall to form an internal chamber. A water based fluid having sugar, such as a diet sweetener, and CO2 is located within the internal chamber. A portion of headspace between the water based fluid and the top wall sized to permit expansion of the water based fluid during freezing without rupturing the container. The container having a rupture strength greater than a conventional pop can of about 105 pounds per square inch. The top wall includes a removable portion that provides an opening to the internal chamber to facilitate the removal of palatable ice from the internal chamber, where the removable portion covers at least a majority of the surface of the top wall.

### DESCRIPTION OF THE DRAWINGS

FIG. 1 is a perspective view of the device of this invention;

FIG. 2 is a sectional side view of the device of this invention taken on line 2-2 of FIG. 1; and

FIG. 3 is a sectional side view of another embodiment of the device of this invention taken on line 2-2 of FIG. 1; and

FIG. 4 is a sectional side view of an alternative device of this invention.

### DESCRIPTION OF THE PREFERRED EMBODIMENT

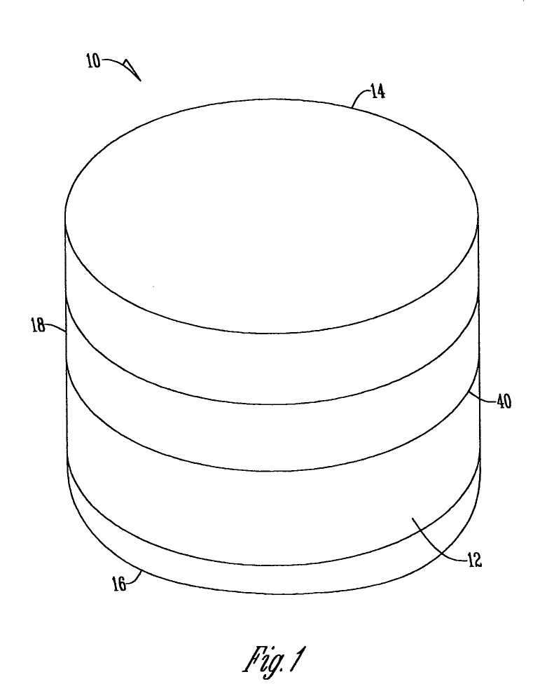

With reference to FIG. 1, a container 10 includes a cup 12 and a cap 14 removably joined to the cup 12. In general, the container 10 may be sized to have a height approximately equal to the height of a soda can, and a width approximately equal to one and a half soda cans; however, other sizes are possible without departing from the present invention.

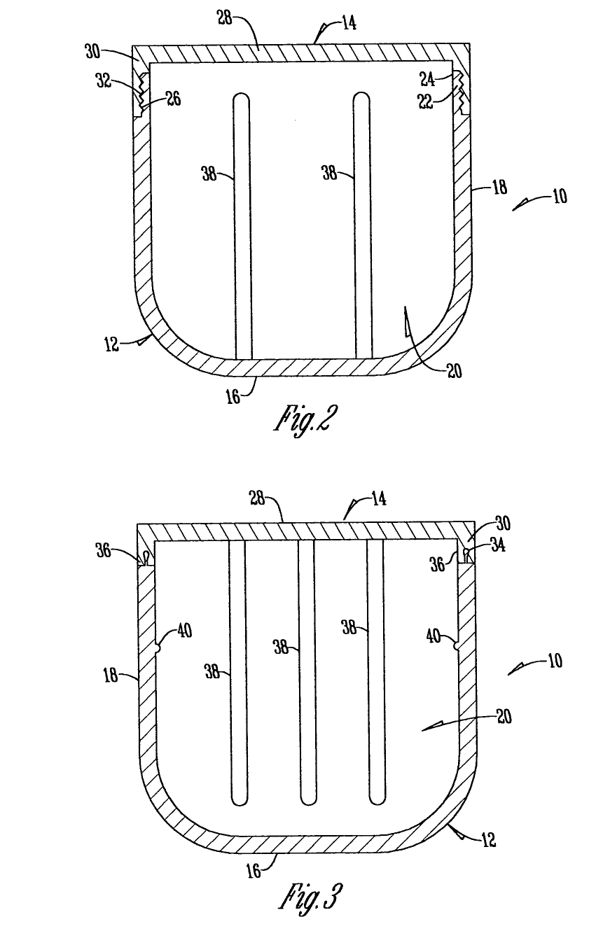

With reference to FIG. 2, the cup 12 is formed of a flexible material, permitting a user to crush frozen material contained within the cup 12. The cup 12 includes a base 16 and an annular side wall 18 extending upwardly from the base 16 to form the internal chamber 20. The annular side wall 18 terminates in an annular rim 22 defining an opening 24 to internal chamber 20.

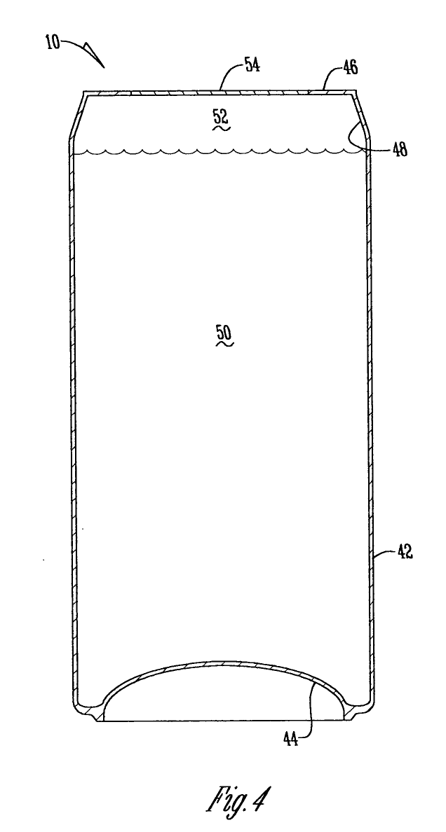

The cap 14 has a cover 28 and an annular flange 30 extending downwardly from the cover 28 which is releasably secured to the cup 12. In one embodiment, as shown in FIG. 2, the annular rim 22 of the cup 12 has external threads 26 that threadably receive internal threads 32 on the internal surface of the flange 30 of the cup 12. In an alternative embodiment, as shown in FIG. 3, the cup 12 has a male protrusion 34 that extends upwardly from the sidewall 18 of the cup 12 and is frictionally received within a female slot 36 disposed within the flange 30 of the cap 14. While these examples have been set forth, any conventional means of releasably securing the cap 14 to the cup 12 can be used.

With reference to FIGS. 2 and 3, at least one void member 38 is sized to be removably located within the interior chamber 20 of the cup 12. The void members 38 preferably are formed of plastic, metal, or any other suitable material. The void members 38 are not hollow and are formed of a solid piece of material. The void members may have a tapered lower end positioned adjacent to the cap. This tapered lower end decreases the force needed to remove the void members 38 from the interior chamber 20 when the interior chamber 20 contains frozen material. As shown in FIG. 2, the void members 38 are placed within the internal chamber 20 of cup 12 and are not connected to the cup 12 or the cap 14. As shown in FIG. 3, the void members 38 are connected to the cap 14 and are removed from the internal chamber 20 when the cap 14 is removed from the cup 12.

Alternatively, the use of expandable and/or flexible material to form the container 10, allows the container 10 to form carbonated ice without exploding. Additionally, the use of expandable and/or flexible material to form the container 10, allows the container 10 to increase the pressure created effects of forming carbonated ice under pressure, while eliminating or reducing the need for the void members 38.

With reference to FIGS. 1 and 3, an indicium 40 on the cup 12 indicates a desired amount of fluid to be added to the cup 12. As shown in FIG. 1, the indicium 40 is formed on the outer surface of the cup 12. In this embodiment, the cup 12 may be formed of transparent or translucent material so that the indicium 40 may be internally visible within the cup 12, or so that the fluid level within the cup 12 can be externally compared with the indicium 40. As shown in FIG. 3, the indicium 40 is formed on the inner or outer surface of the cup 12. While the indicium 40 is shown as physically extending from the inner surface of the cup 12; it will be understood that the indicium 40 may be instead printed on the inner surface of the cup 12. The void members 38 and indicium 40 are oriented and arranged so that the void members 38 extend above and below the indicium 40 when the void members 38 are placed within the interior chamber 20.

With reference to FIG. 4, an alternative container 10 includes a cylindrical outer wall 42 with a lower end enclosed by a bottom wall 44 and an upper end enclosed by a top wall 46 to form an internal chamber 48. The container 10 is formed to have height, width, and diameter dimensions consistent with a conventional pop can. Accordingly, the internal chamber 48 has a total volume 48 of 12.95+/−0.06 fl. oz.

The top wall 46 includes a removable portion 54. The removable portion 54 covers at least a majority of the surface of top wall 46, and may cover the entire top wall 46. The removal of removable portion 54 provides an enlarged opening to the internal chamber 48 to facilitate the removal of palatable ice from the internal chamber 48.

In one embodiment, the container 10 has a rupture strength approximately equal to a conventional pop can of 105 pounds per square inch. When filled, the container 10 has a water based fluid 50 having a sugar content CO₂ content. The step of placing the fluid in the container 10 is done at atmospheric pressure. The container is filled to about 11.8 fl. oz. or less. The resultant headspace 52 is approximately ½ inch or more, 1.15+/−0.06 fl. oz., and about 8.88 percent or more of the total volume 48 of the container. The more headspace 52 given, serves as a cushion for the volume needed in the expansion process. As the expansion takes place, the increased pressure forces the CO₂ gas in the headspace 52 into the ice, creating clathrates or carbon dioxide hydrate. The expansion and clathrate process exchanges CO2 in the headspace 52 for increased CO2 in the ice thus producing palatable ice.

In another embodiment, the container 10 has a rupture strength greater than a conventional pop can of 105 pounds per square inch. In this embodiment, the headspace 52 may be less than ½ inch as the expansion forces of the fluid 50 are accommodated by the strengthened container 10. The strengthened container 10 is formed with a strengthened outer wall 42, bottom wall 44, and top wall 46 to have rupture strength capable of withstanding the pressure created from the expanding fluid 50 during freezing.

In use, the container 10 is utilized to form a carbonated ice by first supplying a water based fluid having a weight percent of sugar of at least about 6% and a CO2 volume of at least about 2, and placing the fluid in the container 10. At sea level pressure and 68° F. 1 CO2 volume has a ratio of CO₂ molecules to H₂O molecules of 1 to 5.75. The container 10 is only partially filled to the indicium 40, leaving a portion of headspace in the container 10 free of fluid, sufficient to permit about a 50% expansion of the water based fluid. Desired is a headspace of at least about 10% of the total volume and preferably between at least about 20% and at least about 60% of the total volume of the container. Acceptable freezing is found from at least about 40% to 50% of the total volume of the container, where low strength polypropylene containers were used. However, the desired headspace is greatly affected by the strength of the container as well as the ability of any CO2 gas to escape. In stronger containers, less headspace is required as the container can withstand greater pressures. Accordingly, the indicium 40 is located in a suitable position on the cup 12 to achieve the desired headspace.

The container 10 is then sealed, and placed in a cooled environment to freeze at least a portion of the water based fluid into carbonated ice. As the fluid freezes, the void members 38 create voids in the carbonated ice. Once frozen, or partially frozen, the container 10 is removed from the cooled environment, and the void members 38 are removed from the carbonated ice, leaving the voids in the carbonated ice open. Applying pressure to the sidewalls 18 of the cup 12, the carbonated ice is crushed. The voids formed in the carbonated ice by the void members 38 reduce the structural integrity of the carbonated ice, thus reducing the amount of force required to crush the carbonated ice in the cup 12. Once crushed, the carbonated ice is ready for consumption, or may be further modified with syrups or the like prior to consumption. Alternatively, the syrup may be added to the water based fluid prior to the freezing process.

The container 10 may be adapted for various target customers, such as commercial scale customers, convenience customers, and home use customers. For take home customers the container 10 is included in a kit with cans of soda, packet of flavoring syrup, and instructions to turn the contents of the can of pop into a consumable confection snow-like product. Upon freezing the soda in the container 10, the contents are crushed in the snow-like product and the flavoring syrup is added. The confection snow-like product is ready for consumption. For commercial scale customers the container 10 is enlarged, for example, for freezing 5 or more serving of the contents of soda cans. The frozen container is removed from the freezer, crushed, and scooped for individual servings. For convenience customers the container 10 is optionally designed as a single use disposable container where the container 10 is sold already frozen. The contents are crushed into the confection snow-like product and either the flavoring syrup is added or the flavoring was already in the contents of the soda and is ready for consumption.

The composition formed in the container is a carbonated ice having a weight percent of sugar of about 6% or greater and a CO2 volume of at least about 2 or greater, wherein the carbonated ice has about a 50% expansion from a fluid phase to the solid phase. The concentration of sugar is preferably from a weight percent of about 6% to a weight percent of about 20%, and more preferably from a weight percent of about 6% to a weight percent of about 12%. The sugar is preferably fructose, but may be fructose, sucrose, glucose, splenda, sucralose, maltodextrine, combinations thereof, or any other suitable sugar, any other suitable diet sweetener or suitable combination thereof. The CO2 volume is preferably from about 2 to about 4.

### EXAMPLES

In the examples below, multiple carbonated water based fluids including a sugar component were evaluated in polypropylene bottles. Variations in sugar concentration, carbonation level, and headspace were evaluated for their effect on the produced carbonated ice.

A baseline fluid was established based on commercially available carbonated soft drink having a sugar content of 12% weight and a CO2 volume of 4.

### Example 1

### Concentration of Sugar

For Example 1, the concentration of CO₂ was maintained at the level of the baseline fluid, but the sugar content was varied. The sugar supplied was a fructose syrup (as Cargill-55 fructose syrup). The fructose syrup was added to 20 ml samples of carbonated water in a 35 ml container and frozen for one hour.

Acceptable expansion of about a 50% expansion from the fluid phase to the solid phase was seen in the samples with 60% or more fructose content as compared with the baseline fluid.

TABLE 1

| % of sugar | Wt of | | |
|---|---|---|---|
| per | fructose | Carbonated | |
| baseline | (g) | water (ml) | Comments |
| 20% | .49 | 20 | Very little |
| | | | expansion |
| 40% | .96 | 20 | Less than 50% |
| | | | expansion |
| 60% | 1.46 | 20 | Near 50% |
| | | | expansion |
| 80% | 1.90 | 20 | Approximately |
| | | | 50% expansion |
| 100% | 2.46 | 20 | Approximately |
| | | | 50% expansion |
| 120% | 2.89 | 20 | Approximately |
| | | | 50% expansion |
| 140% | 3.37 | 20 | Approximately |
| | | | 50% expansion |
| 160% | 3.83 | 20 | Approximately |
| | | | 50% expansion |

### Example 2

### Concentration of Sugar

Similar to Example 1, in Example 2 the concentration of CO₂ was maintained at the level of the baseline fluid, but the sugar content was varied. The sugar supplied was a fructose syrup (as Cargill-55 fructose syrup). The fructose syrup was added to 20 ml samples of carbonated water in a 35 ml container, and unlike Example 1, frozen for four hours.

Acceptable expansion of about a 50% expansion from the fluid phase to the solid phase was seen in the samples with 40% or more fructose content as compared with the baseline fluid.

TABLE 2

| % of sugar | Wt of | | |
|---|---|---|---|
| per | fructose | Carbonated | |
| baseline | (g) | water (ml) | Comments |
| 40% | .96 | 20 | Approximately |
| | | | 50% expansion |
| 50% | 1.20 | 20 | Approximately |
| | | | 50% expansion |
| 60% | 1.48 | 20 | Approximately |
| | | | 50% expansion |
| 70% | 1.69 | 20 | Approximately |
| | | | 50% expansion |
| 80% | 1.91 | 20 | Approximately |
| | | | 50% expansion |
| 90% | 2.17 | 20 | Approximately |
| | | | 50% expansion |
| 100% | 2.43 | 20 | Approximately |
| | | | 50% expansion |

### Example 3

### Amount of Carbonation

For Example 3, the concentration of CO₂ was varied and tested at various levels of sugar content. The sugar supplied was a fructose syrup (as Cargill-55 fructose syrup). The fructose syrup was added to varied samples of carbonated water with a total volume of fluid being 20 ml in a 35 ml container and frozen.

Acceptable expansion of about a 50% expansion from the fluid phase to the solid phase was seen in the samples with 50% or more CO₂ content as compared with the baseline fluid.

TABLE 3

| | | Carbonated water | | |
|---|---|---|---|---|
| | | (ml) | | |
| % of sugar | % of CO₂ | Concentrated | | |
| per | per | carbonated | | |
| baseline | baseline | water | H₂O | Comments |
| 50% | 0% | 0 | 20 | Less than 50% |
| | | | | expansion |
| 50% | 25% | 5 | 15 | Less than 50% |
| | | | | expansion |
| 50% | 50% | 10 | 10 | Approximately |
| | | | | 50% expansion |
| 50% | 75% | 15 | 5 | Approximately |
| | | | | 50% expansion |
| 50% | 100% | 20 | 0 | Approximately |
| | | | | 50% expansion |
| 70% | 25% | 5 | 15 | Less than 50% |
| | | | | expansion |
| 70% | 50% | 10 | 10 | Less than 50% |
| | | | | expansion |
| 70% | 75% | 15 | 5 | Approximately |
| | | | | 50% expansion |
| 70% | 100% | 20 | 0 | Approximately |
| | | | | 50% expansion |
| 90% | 25% | 5 | 15 | Less than 50% |
| | | | | expansion |
| 90% | 50% | 10 | 10 | Approximately |
| | | | | 50% expansion |
| 90% | 75% | 15 | 5 | Approximately |
| | | | | 50% expansion |
| 90% | 100% | 20 | 0 | Approximately |
| | | | | 50% expansion |
| 100% | 0% | 0 | 20 | Less than 50% |
| | | | | expansion |
| 100% | 25% | 5 | 15 | Less than 50% |
| | | | | expansion |
| 100% | 50% | 10 | 10 | Approximately |
| | | | | 50% expansion |
| 100% | 75% | 15 | 5 | Approximately |
| | | | | 50% expansion |
| 100% | 100% | 20 | 0 | Approximately |
| | | | | 50% expansion |

### Example 4

### Amount of Headspace

For Example 4, the concentration of CO₂ and sugar were maintained at the level of the baseline fluid. The volume of the fluid added to the 50 ml container was varied to create a varied amount of headspace in each container.

Acceptable expansion from the fluid phase to the solid phase was seen in the samples with greater than 10% headspace. Acceptable expansion of about a 50% expansion from the fluid phase to the solid phase was seen in the samples with greater than 40% headspace.

TABLE 4

| | Headspace as % | Fluid | |
|---|---|---|---|
| Headspace | of container | volume | |
| (ml) | volume | (ml) | Comments |
| 40 | 80 | 10 | Expanded to 16 ml |
| 30 | 60 | 20 | Expanded to 30 ml |
| 20 | 40 | 30 | Expanded to 35 ml |
| 10 | 20 | 40 | container full, |
| | | | product at desired |
| | | | consistency |
| 5 | 10 | 45 | container full, |
| | | | product at desired |
| | | | consistency |

It is therefore seen that this invention will accomplish at least all of its stated objectives.

I claim:

1. A method of producing a palatable carbonated ice, comprising the steps of:
supplying a water based fluid having sugar and CO2;
placing the fluid in a container;
leaving a portion of headspace in the container free of fluid, the headspace sized to permit expansion of the water based fluid during freezing without rupturing the container;
sealing the container; and
freezing at least a portion of the water based fluid into carbonated ice without rupturing the container during freezing.

2. The method of claim 1, wherein the headspace is at least 8.88 percent total volume of the container.

3. The method of claim 1, wherein the container has a rupture strength greater than a conventional pop can of about 105 pounds per square inch.

4. The method of claim 1, wherein the step of placing the fluid in a container is done at atmospheric pressure.

5. The method of claim 1, further comprising the step of creating voids in the carbonated ice during the freezing of the water based fluid into carbonated ice.

6. The method of claim 1, wherein the water based fluid has a weight percent of sugar of at least about 6% and a CO2 volume of at least about 2.

7. The method of claim 1, wherein the sugar is selected from the group consisting of fructose, sucrose, glucose, and combinations thereof.

8. The method of claim 1, wherein the sugar is a diet sweetener selected from the group consisting of splenda, sucralose, maltodextrine, and combinations thereof.

9. A container for forming a palatable carbonated ice under pressure, comprising:
an outer wall with a lower end enclosed by a bottom wall and an upper end enclosed by a top wall to form an internal chamber;
a water based fluid having sugar and CO₂ located within the internal chamber; and
a portion of headspace between the water based fluid and the top wall, the headspace being sized to permit expansion of the water based fluid during freezing without rupturing the container.

10. The container of claim 9, wherein the headspace is at least 8.88 percent total volume of the container.

11. The container of claim 9, wherein the container has a rupture strength greater than a conventional pop can of about 105 pounds per square inch.

12. The container of claim 9, wherein the top wall includes a removable portion that provides an opening to the internal chamber to facilitate the removal of palatable ice from the internal chamber, where the removable portion covers at least a majority of the surface of the top wall.

13. The container of claim 9, wherein the water based fluid has a weight percent of sugar of at least about 6% and a CO2 volume of at least about 2.

14. The container of claim 9, wherein the sugar is selected from the group consisting of fructose, sucrose, glucose, and combinations thereof.

15. The container of claim 9, wherein the sugar is a diet sweetener from the group consisting of splenda, sucralose, maltodextrine, and combinations thereof.

16. The container of Claim 9, wherein a void member is removably located within the interior chamber.
